(19) United States
(12) Patent Application Publication
(10) Pub. No.: US 2026/0034741 A1
(43) Pub. Date: Feb. 5, 2026

(54) DATA GENERATION METHOD

(71) Applicant: SEIKO EPSON CORPORATION, Tokyo (JP)

(72) Inventor: Wataru ENDO, SHIOJIRI-SHI (JP)

(21) Appl. No.: 19/284,490

(22) Filed: Jul. 29, 2025

(30) Foreign Application Priority Data
Jul. 31, 2024 (JP) 2024-124111

(51) Int. Cl. B29C 64/393; B29C 64/40; B33Y 50/02

(52) U.S. Cl. CPC B29C 64/393; B29C 64/40; B33Y 50/02

(57) ABSTRACT

A data generation method for generating molding data for molding a three dimensional molded object by ejecting a molding material onto a molding surface of a stage to stack layers of the molding material, the data generation method includes a receiving step of displaying at least a part of an overhang section of the three dimensional molded object on a display section and receiving selection of a first region representing at least a part of the overhang section on the display section; a region determining step of determining a second region representing at least a part of the overhang section based on a characteristic amount of the selected first region; and a generating step of generating data representing a support structure for supporting the determined second region from below in a stacking direction of the layers. The characteristic amount includes a characteristic angle representing an angle of the first region with respect to the molding surface.

The present application is based on, and claims priority from JP Application Serial Number 2024-124111, filed Jul. 31, 2024, the disclosure of which is hereby incorporated by reference herein in its entirety.

### BACKGROUND

### 1. Technical Field

The present disclosure relates to a data generation method.

### 2. Related Art

Regarding a data generation method for generating molding data for molding a three dimensional molded object, JP-A-2018-47623 discloses a technology for automatically setting a molding position of a support structure that supports a three dimensional molded object.

When the support structure is set automatically, as in JP-A-2018-47623, there is a possibility that the support structure desired by a user will not be reflected in the molding data. However, it is inefficient to manually set the support structure from the beginning or additionally in order to reflect the desired support structure in the molding data.

### SUMMARY

According to an aspect of the present disclosure, there is provided a data generation method for generating molding data for molding a three dimensional molded object by ejecting a molding material onto a molding surface of a stage to stack layers of the molding material.

This data generation method includes a receiving step of displaying at least a part of an overhang section of the three dimensional molded object on a display section and of receiving selection of a first region representing at least a part of the overhang section on the display section; a region determining step of determining a second region representing at least a part of the overhang section based on a characteristic amount of the selected first region; and a generating step of generating data representing a support structure for supporting the determined second region from below in a stacking direction of the layers.

the characteristic amount includes a characteristic angle representing an angle of the first region with respect to the molding surface.

### BRIEF DESCRIPTION OF THE DRAWINGS

FIG. 1 is an explanatory diagram showing a schematic configuration of a three dimensional molding system according to a first embodiment.

FIG. 2 is a perspective diagram showing a schematic configuration of a lower surface side of a flat screw.

FIG. 3 is a schematic plan diagram showing the upper surface side of a barrel.

FIG. 4 is an explanatory diagram schematically showing a state in which the three dimensional molding device molds a molded object.

FIG. 5 is an explanatory diagram showing a schematic configuration of an information processing device.

FIG. 6 is a flowchart of a molding process.

FIG. 7 is a diagram showing a first example of a data generation process according to the first embodiment;

FIG. 8 is a diagram showing a second example of the data generation process according to the first embodiment.

FIG. 9 is a diagram showing a third example of the data generation process according to the first embodiment.

FIG. 10 is a diagram showing a fourth example of the data generation process according to the first embodiment.

FIG. 11 is a diagram showing a fifth example of the data generation process according to the first embodiment.

FIG. 12 is a schematic diagram showing a first example of a data generation process according to a second embodiment.

FIG. 13 is a diagram showing a first example of path information included in support data.

FIG. 14 is a diagram showing a second example of the path information included in the support data.

FIG. 15 is a diagram showing a third example of the path information included in the support data.

FIG. 16 is a diagram showing a second example of a data generation process according to the second embodiment.

FIG. 17 is a diagram showing a first example of a data generation process according to another embodiment.

FIG. 18 is a diagram showing a second example of the data generation process according to another embodiment.

FIG. 19 is a diagram showing a third example of the data generation process according to another embodiment.

### DESCRIPTION OF EMBODIMENTS

### a. First Embodiment

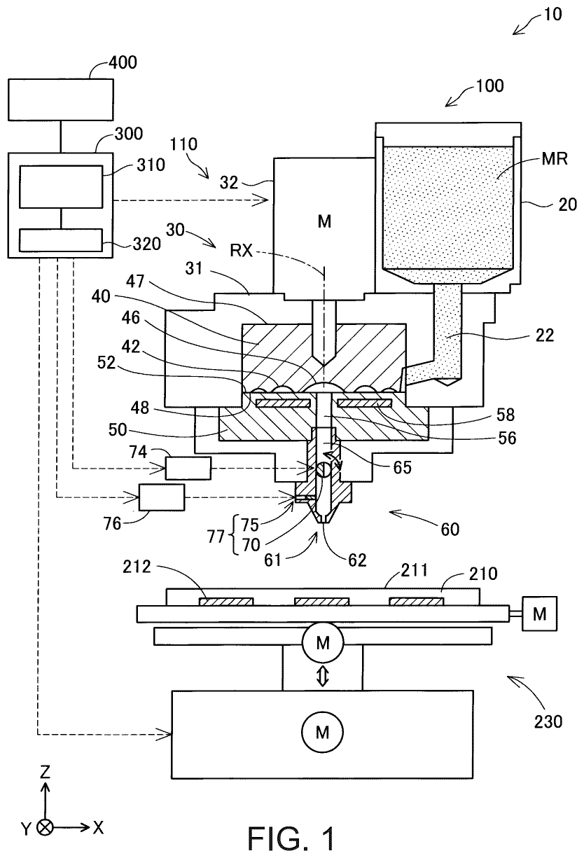

FIG. 1 is an explanatory diagram showing a schematic configuration of a three dimensional molding system 10 according to a first embodiment. In FIG. 1, arrows indicating X, Y, and Z directions orthogonal to each other are shown. The X direction and the Y direction are directions parallel to a horizontal plane, and the Z direction is a direction along a vertically upward direction. The arrows indicating the X, Y, and Z directions are appropriately shown in other drawings so that the shown directions correspond to those in FIG. 1. In the following description, when a direction is specified, a direction indicated by an arrow in each drawing is referred to as “+” and an opposite direction is referred to as “−”, and positive and negative signs are used in combination for direction notation. Hereinafter, the +Z direction is also referred to as “upper”, and the −Z direction is also referred to as “lower”.

The three dimensional molding system 10 includes a three dimensional molding device 100 and an information processing device 400. The three dimensional molding device 100 of the present embodiment is a device that molds a molded object by a material extrusion method. The three dimensional molding device 100 includes a control section 300 for controlling each section of the three dimensional molding device 100. The control section 300 and the information processing device 400 are connected so that they can communicate with each other.

The three dimensional molding device 100 is equipped with a molding section 110, which generates and ejects a molding material, a stage 210 for molding, which serves as a base of the molded object, and a movement mechanism 230, which controls a position where the molding material is ejected.

The molding section 110 ejects the molding material, which is plasticized from solid state material, onto the stage 210 under the control of the control section 300. The molding section 110 includes a material supply section 20, which is the supply source of raw material before it is converted into the molding material, a plasticizing section 30, which converts the raw material into the molding material, and an ejection section 60, which ejects the molding material.

The material supply section 20 supplies a raw material MR to the plasticizing section 30. The material supply section 20 is constituted by, for example, a hopper that accommodates the raw material MR. The material supply section 20 is connected to the plasticizing section 30 via a communication path 22. The raw material MR is supplied to the material supply section 20 in the form of powder or pellets. As the raw material MR, for example, a thermoplastic resin such as an acrylonitrile-butadiene-styrene resin (ABS), a polypropylene resin (PP), a polyethylene resin (PE), or a polyacetal resin (POM) is used.

The plasticizing section 30 plasticizes the raw material MR, which is supplied from the material supply section 20, to generate a paste-like molding material, which has fluidity, and leads it to the ejection section 60. In the present embodiment, “plasticization” is a concept including melting, and is a change from a solid state to a state having fluidity. Specifically, in the case of a material in which glass transition occurs, plasticization means that the temperature of the material is set to be equal to or higher than the glass transition point. For material that does not undergo glass transition, “plasticization” means that the temperature of the material is raised to or above the melting point.

The plasticizing section 30 has a screw case 31, a drive motor 32, a flat screw 40, and a barrel 50. The flat screw 40 is also referred to as a rotor or scroll. The barrel 50 is also referred to as a screw facing section.

The flat screw 40 is housed in the screw case 31. An upper surface 47 of the flat screw 40 is connected to the drive motor 32, and the flat screw 40 is rotated in the screw case 31 by a rotational drive force generated by the drive motor 32. The drive motor 32 is driven under the control of the control section 300. The flat screw 40 may be driven by the drive motor 32 via a decelerator.

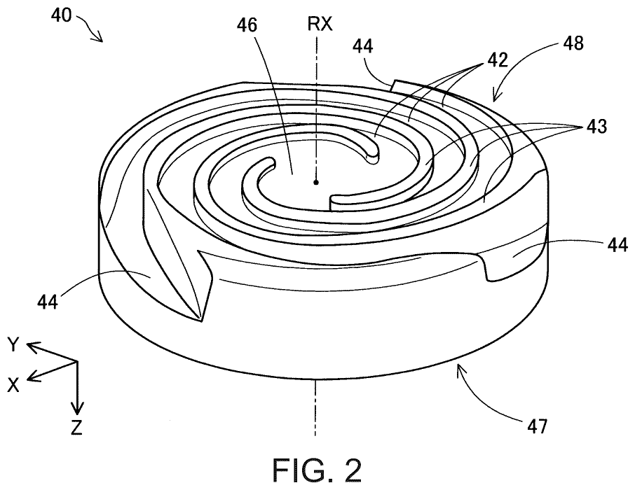

FIG. 2 is a perspective diagram showing a schematic configuration of a lower surface 48 side of the flat screw 40. The flat screw 40 shown in FIG. 2 is shown with a positional relationship between the upper surface 47 and the lower surface 48 shown in FIG. 1 reversed in the vertical direction for facilitating understanding of the technology. The flat screw 40 has a substantially cylindrical shape whose length in an axial direction, which is a direction along its central axis, is smaller than a length in a direction perpendicular to the axial direction. The flat screw 40 is disposed so that a rotation axis RX, which serves as a rotation center of the flat screw 40, is parallel to the Z direction.

Vortex shape groove sections 42 are formed on the lower surface 48 of the flat screw 40, which is a surface intersecting the rotation axis RX. The communication path 22 of the material supply section 20 described above communicates with the groove sections 42 from the side surface of the flat screw 40. In the present embodiment, three groove sections 42, which are spaced apart, are formed by ridge sections 43. Note that the number of groove sections 42 is not limited to three, and may be one or two or more. The groove sections 42 is not limited to the vortex shape, may be a helical shape or an involute curvilinear, or may be a shape extending so as to draw an arc shape from the central section to the outer circumference.

As shown in FIG. 1, the lower surface 48 of the flat screw 40 faces an upper surface 52 of the barrel 50, and a space is formed between the groove section 42 of the lower surface 48 of the flat screw 40 and the upper surface 52 of the barrel 50. The raw material MR is supplied into this space between the flat screw 40 and the barrel 50 from the material supply section 20 through a material inflow port 44 shown in FIG. 2.

A barrel heater 58 is embedded in the barrel 50 to heat the raw material MR fed into the groove sections 42 of the rotating flat screw 40. A communication hole 56 is provided at the center of the barrel 50.

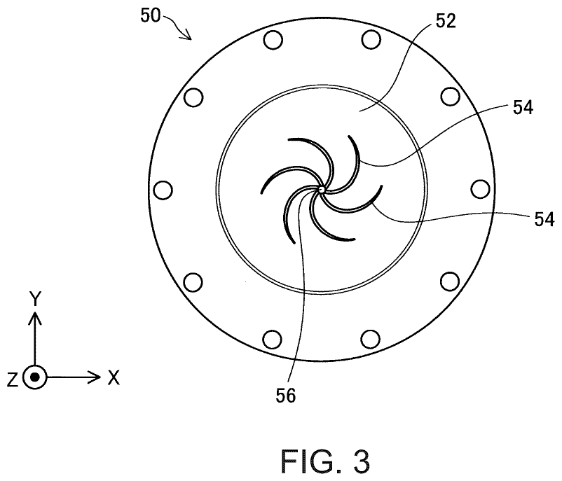

FIG. 3 is a schematic plan diagram showing the upper surface 52 of the barrel 50. On the upper surface 52 of the barrel 50, a plurality of guide grooves 54 are formed, which are connected to the communication hole 56 and extend in the vortex shape from the communication hole 56 toward the outer circumference. Note that one end of the guide grooves 54 may not be connected to the communication hole 56. It is also possible to omit the guide grooves 54.

The raw material MR supplied into the groove sections 42 of the flat screw 40 flows along the groove sections 42 by the rotation of the flat screw 40 while being plasticized in the groove sections 42, and is leads to a central section 46 of the flat screw 40 as the molding material. The paste-like molding material, which has fluidity and flowed into the central section 46, is supplied to the ejection section 60 through the communication hole 56 provided in the center of the barrel 50. Note that in the molding material, not all types of substances that constitute the molding material need to be plasticized. The molding material should be converted into a fluidity state as a whole by plasticizing at least some types of substances that constitute the molding material.

The ejection section 60 in FIG. 1 includes a nozzle 61, which ejects the molding material, a flow path 65 for the molding material, which is provided between the flat screw 40 and an nozzle opening 62, and a ejection control section 77, which controls the eject of the molding material.

The nozzle 61 is connected to the communication hole 56 of the barrel 50 through the flow path 65. The nozzle 61 ejects the molding material generated in the plasticizing section 30 from the nozzle opening 62, which is the tip end section of the nozzle 61, toward the stage 210.

The ejection control section 77 includes an ejection adjustment section 70 that opens and closes the flow path 65, and a suction section 75 that sucks and temporarily stores the molding material.

The ejection adjustment section 70 is provided in the flow path 65, and changes the opening degree of the flow path 65 by rotating in the flow path 65. In the present embodiment, the ejection adjustment section 70 is constituted by a valve. The ejection adjustment section 70 is driven by a first drive section 74 under the control of the control section 300. The first drive section 74 is constituted by, for example, a stepping motor. The control section 300 can adjust the flow rate of the molding material flowing from the plasticizing section 30 to the nozzle 61, that is, the ejection amount of the molding material ejected from the nozzle 61 by controlling the rotation angle of the ejection adjustment section 70 using the first drive section 74. The ejection adjustment section 70 can adjust the ejection amount of the molding material and can control the ON and OFF of the outflow of the molding material.

The suction section 75 is connected between the ejection adjustment section 70 and the nozzle opening 62 in the flow path 65. The suction section 75 temporarily sucks the molding material from the flow path 65 when the eject of the molding material from nozzle 61 is stopped, thereby suppressing a tailing phenomenon where the molding material drips from nozzle opening 62 in a string-like manner. In the present embodiment, the suction section 75 is constituted by a plunger. The suction section 75 is driven by a second drive section 76 under the control of the control section 300. The second drive section 76 is constituted by, for example, a stepping motor and a rack and pinion mechanism that converts the rotational force of the stepping motor into the translational movement of the plunger.

The stage 210 is positioned at a position facing the nozzle opening 62 of the nozzle 61. In the first embodiment, a molding surface 211 of the stage 210, which faces the nozzle opening 62 of the nozzle 61, is disposed to be parallel to the X and Y directions, that is, the horizontal direction. The stage 210 has a stage heater 212 that suppresses rapid cooling of the molding material ejected onto the stage 210. The stage heater 212 is controlled by the control section 300.

The movement mechanism 230 changes the relative position between the stage 210 and the nozzle 61 under the control of the control section 300. In the present embodiment, the position of the nozzle 61 is fixed, and the movement mechanism 230 moves the stage 210. The movement mechanism 230 is constituted by a three axis positioner that moves the stage 210 in the three axis directions of X, Y, and Z by the driving forces of three motors. In the present specification, unless otherwise specified, movement of the nozzle 61 means that the nozzle 61 or the ejection section 60 is relatively moved with respect to the stage 210.

Note that in another embodiment, instead of the configuration in which the stage 210 is moved by the movement mechanism 230, a configuration may be adopted in which the position of the stage 210 is fixed and the movement mechanism 230 moves the nozzle 61 with respect to the stage 210. A configuration in which the movement mechanism 230 moves the stage 210 in the Z direction and the nozzle 61 in the X and Y directions, or a configuration in which the movement mechanism 230 moves the stage 210 in the X and Y directions and the nozzle 61 in the Z direction, may be adopted. Even using these configurations, the relative positional relationship between the nozzle 61 and the stage 210 can be changed.

Although only one molding section 110 is shown in FIG. 1, the three dimensional molding device 100 may be equipped with a plurality of molding sections 110. By providing the plurality of molding sections 110, different types of molding materials can be ejected from each molding section 110. Therefore, for example, a model (to be described later) and a support structure that supports the model can be molded with different types of molding materials.

The control section 300 is a control device that controls operation of the entire three dimensional molding device 100. The control section 300 is configured with a computer with one or more processors 310, a storage device 320 consisting of a main storage device and an auxiliary storage device, and an input and output interface for input and output of signals to and from the outside. The processor 310, by executing the program stored in the storage device 320, controls the molding section 110 and the movement mechanism 230 to mold the molded object on the stage 210 according to molding data obtained from the information processing device 400. Details of the molding data will be described later. Note that the control section 300 may be realized by a configuration of a combination of circuits, instead of being configured by the computer.

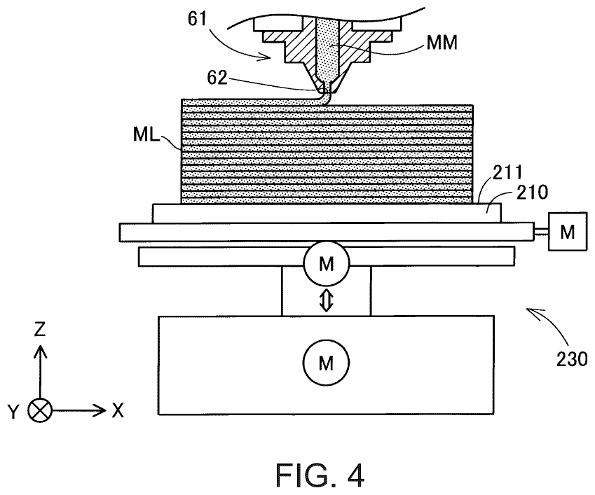

FIG. 4 is an explanatory diagram schematically showing a state in which the three dimensional molding device 100 molds the molded object. In the three dimensional molding device 100, as described above, a molding material MM is generated by plasticizing the solid state raw material MR. The control section 300 maintains the distance between the molding surface 211 of the stage 210 and the nozzle 61, and ejects molding material MM from the nozzle 61 in the direction along the molding surface 211 of the stage 210 while changing the position of the nozzle 61 with respect to the stage 210. The molding material MM ejected from the nozzle 61 is continuously deposited in the movement direction of the nozzle 61.

The control section 300 forms a layer ML by repeating the movement of the nozzle 61. After molding one layer ML, the control section 300 moves the position of the nozzle 61 relative to the stage 210 in the Z direction, which is a stacking direction of the layers ML. Then, by further stacking layers ML on the layers ML formed so far, the molded object is molded.

The control section 300 may temporarily suspend the ejection of the molding material from the nozzle 61, for example, when the nozzle 61 moves in the Z direction when one layer ML is completed, or when there are a plurality of independent molding regions in each layer. In this case, the ejection adjustment section 70 closes the flow path 65 to stop the eject of molding material MM from the nozzle opening 62, and the suction section 75 temporarily sucks the molding material inside the nozzle 61. After changing the position of nozzle 61, the control section 300 resumes the deposition of molding material MM from the changed position of nozzle 61 by opening the flow path 65 by the ejection adjustment section 70 while discharging the molding material sucked into the suction section 75.

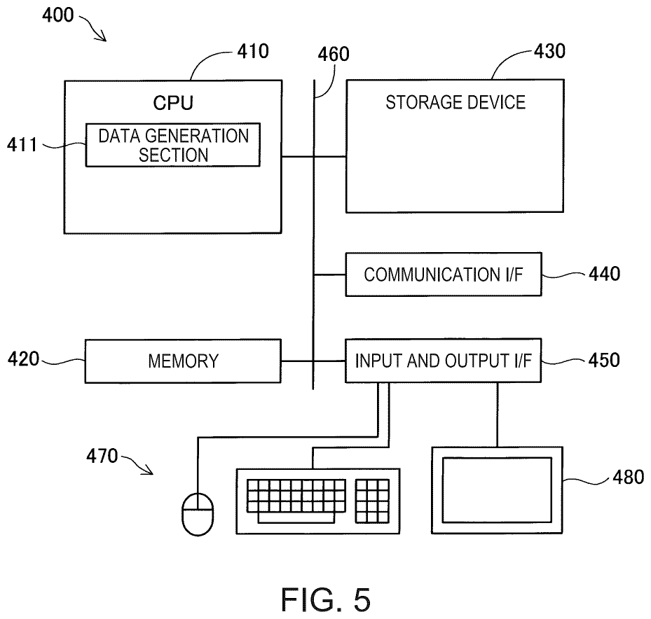

FIG. 5 is an explanatory diagram showing a schematic configuration of the information processing device 400. The information processing device 400 is configured as a computer in which a CPU 410, a memory 420, a storage device 430, a communication interface 440, and an input and output interface 450 are connected to each other by a bus 460. An input device 470 such as a keyboard or a mouse and a display section 480 such as a liquid crystal display are connected to the input and output interface 450. The information processing device 400 is connected to the control section 300 of the three dimensional molding device 100 via the communication interface 440.

The CPU 410 functions as a data generation section 411 by executing a program stored in the storage device 430. The data generation section 411 generates the molding data used by the three dimensional molding device 100 to mold a three dimensional molded object.

In the present embodiment, the molding data includes first molding data and second molding data. The first molding data is molding data that is a basis for generating the second molding data. The first molding data includes model data. The model data is data for molding the model as the three dimensional molded object. The second molding data includes the model data and support data. In the present embodiment, the first molding data does not include the support data. The support data is data for molding the support structure as a three dimensional molded object. The support structure supports the model from below in the stacking direction. The support structure is mainly used to support the model during three dimensional molding, and is detached and removed from the model after three dimensional molding. The support structure in the present embodiment is block-shaped. The meaning of the block-shaped includes plate-shaped.

More specifically, the support structure supports an overhang section from below. The overhang section refers to a portion of the model that protrudes without support below. In the present embodiment, the term “overhang section” also includes a bridge section. The bridge section refers to a portion in the model that is a bridge-like portion supported at both ends. More specifically, the overhang section is defined as a portion of the model that has no support below it, and the molding angle of the lower surface of the portion is equal to or smaller than a predetermined reference angle. The molding angle of a certain portion or a certain region means an angle of the lower surface of the portion or the region with respect to the molding surface 211. In particular, the “molding angle of the lower surface” means an angle of the lower surface with respect to the molding surface 211. The molding angle is defined as an angle of 0 degrees or more and less than 90 degrees. When the molding angle of a certain portion is 0 degrees, the lower surface of the portion is parallel to the molding surface 211. As the molding angle of a certain portion approaches 90 degrees, the lower surface of the portion approaches perpendicular to the molding surface 211. The reference angle is defined as an angle less than 90 degrees. Hereinafter, the lower surface of the overhang section is also referred to as an overhang surface. The molding angle of the overhang section is also referred to as an overhang angle.

The molding data includes path information. The path information is information representing a movement path of the nozzle 61 for each of a plurality of layers obtained by slicing the shape of the three dimensional molded object represented by the model data or the shape of the support structure represented by the support data. The molding data may include information on a filling rate of the infill region and information on an infill pattern. The infill region is a region positioned inside an outer shell region of the three dimensional molded object as viewed in the stacking direction. The filling rate is represented by the ratio of the area of the infill region filled by the molding material to the area of the entire infill region. The infill pattern represents a pattern of the movement path that fills the infill region.

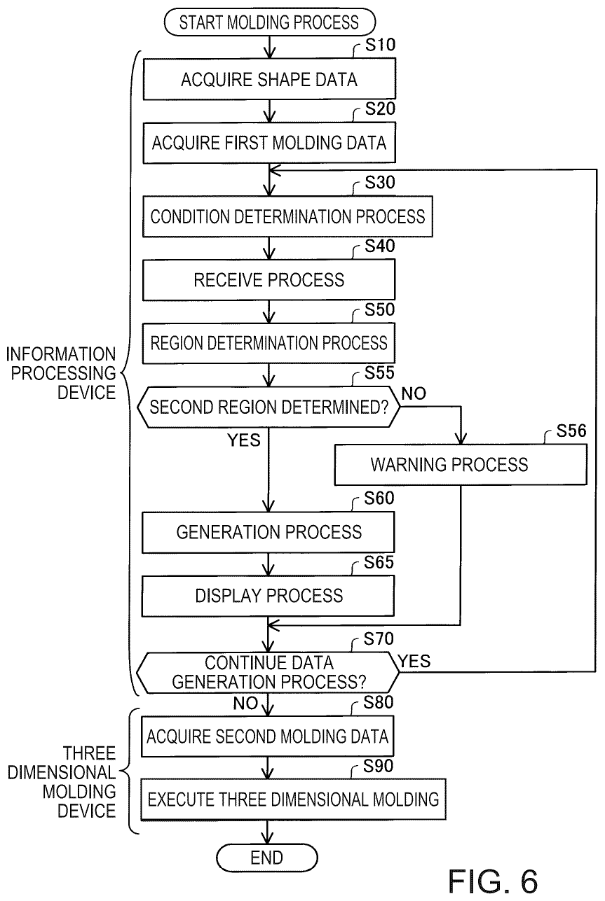

FIG. 6 is a flowchart of a molding process executed in the three dimensional molding system 10. The molding process is a process for realizing a manufacturing method of the three dimensional molded object. The process from step S10 to step S70 shown in FIG. 6 is executed by the information processing device 400, and the processes of step S80 and step S90 is executed by the three dimensional molding device 100. The process from step S10 to step S70 is a process for generating the second molding data including the model data and the support data. The process for generating the second molding data, such as step S10 to step S70, is referred to as a data generation process. In the data generation process in the present embodiment, the second molding data is generated based on the first molding data.

In step S10, the data generation section 411 of the information processing device 400 acquires shape data representing a three dimensional shape of the model from another computer, a recording media, or the storage device 430. The shape data is data representing the shape of the model created using a three dimensional CAD software, a three dimensional CG software, or the like. As the shape data, for example, data in an STL format, an AMF format, or the like is used.

In step S20, the data generation section 411 generates the first molding data as the model data based on the shape data acquired in step S10, and acquires the generated first molding data. More specifically, at step S20, the data generation section 411 analyzes the shape data acquired at step S10 by using a slicer software, thereby generating the first molding data.

In step S30, the data generation section 411 executes a condition determination process. The condition determination process is a process of determining a characteristic condition. The characteristic condition is used to determine a second region (to be described later). In the present embodiment, the data generation section 411 displays a plurality of predetermined conditions as candidates for the characteristic condition on the display section 480, receives selection of a condition on the display section 480, and determines the selected condition as the characteristic condition. In step S30, a single condition may be determined as the characteristic condition, or a plurality of conditions may be determined as the characteristic condition. When the plurality of conditions are determined in step S30, each condition may be used as a logical product, that is, an AND condition, or may be used as a logical sum, that is, an OR condition. In the present embodiment, each condition is used as the logical product. The characteristic condition will be described in detail later.

In step S40, the data generation section 411 executes a receive process. The receive process is a process of displaying at least a part of the overhang section of the three dimensional molded object on the display section 480 and receiving the selection of a first region on the display section 480. The first region is a region representing at least a part of the overhang section. In the present embodiment, the data generation section 411 receives the selection of one facet included in the overhang section as the first region. The facet means one unit of mesh constituting a model surface. The mesh divides the model surface into a plurality of triangles or quadrangles. That is, the facet is a triangle or a quadrangle as a minimum unit constituting the model surface. In the present embodiment, the facets are triangular. In the receiving step, the data generation section 411 causes the user to select the first region by, for example, clicking one point of the overhang section displayed on the display section 480 via the input device 470. A step of executing the receive process, such as step S40, is also referred to as the receiving step.

In step S50, the data generation section 411 executes a region determination process. The region determination process is a process of determining the second region based on the characteristic amount of the first region selected in the receiving step. The second region is a region representing at least a part of the overhang section of the three dimensional molded object. The characteristic amount of the first region used in step S50 includes a characteristic angle. The characteristic angle represents the molding angle of the first region with respect to the molding surface 211. A step of executing the region determination processing, such as step S50, is also referred to as a region determining step.

More specifically, in step S50, the data generation section 411 determines, as the second region, a region that satisfies the characteristic condition determined in step S30, based on the characteristic amount of the first region. The characteristic condition is a condition related to the characteristic amount of the first region. The characteristic conditions in the present embodiment include an equal angle condition, a less than angle condition, and an adjacent continuous condition. The equal angle condition is a condition that the angle of the determination target region with respect to the molding surface 211 is equal to the characteristic angle. The “determination target region” means a region to be determined whether or not the condition is satisfied. The less than angle condition is a condition that the angle of the determination target region with respect to the molding surface 211 is less than the characteristic angle. The adjacent continuous condition is a condition that the determination target region is an adjacent continuous region. The adjacent continuous region includes a plurality of adjacent regions. The adjacent continuous region is an example of a continuous region. The continuous region includes the plurality of adjacent regions, and in the continuous region, an angle difference between the molding angles of the adjacent regions is equal to or less than a predetermined angle threshold. In the present embodiment, one region in the adjacent continuous region means one facet. The adjacent continuous region includes a first adjacent region adjacent to the first region. The adjacent continuous region may include a second adjacent region adjacent to the first adjacent region, a region adjacent to the second adjacent region, and a region further adjacent to the region. The adjacent continuous region may include the first region.

Note that the second region may include the first region. In the present embodiment, the second region includes the first region in a case where the equal angle condition is determined as the characteristic condition and in a case where the adjacent continuous condition is determined as the characteristic condition. On the other hand, when the less than angle condition is determined as the characteristic condition, the second region does not include the first region. In the present embodiment, each condition as a candidate for the characteristic condition is used as a logical product, and thus, when the characteristic condition includes the less than angle condition, the second region does not include the first region as a result.

In step S55, the data generation section 411 determines whether or not the second region has been determined at step S50. When it is determined that the second region is not determined in step S55, the data generation section 411 executes a warning process in step S56. The warning process is a process executed when the second region is not determined in the region determining step, and is a process of displaying a warning on the display section 480. In the warning process, the data generation section 411 may display, on the display section 480, a message for prompting the user to confirm whether or not the selection of the first region is appropriate, or a message for prompting the user to confirm whether or not the selection of the characteristic condition is appropriate, for example. A step of executing the warning process, such as step S56, is also referred to as a warning step. After step S56 is completed, the data generation section 411 advances the process to step S70.

When it is determined that the second region is determined in step S55, the data generation section 411 executes the generation process in step S60. The generation process is a process of generating the support data based on the second region determined in the region determining step. The support data generated in the generation process includes the support data representing the support structure for supporting the second region from below in the stacking direction. The second molding data is generated by executing the generation process. That is, in the present embodiment, the second molding data includes the model data acquired in step S20 and the support data generated in step S60. A step of executing the generation process, such as step S60, is also referred to as a generating step. Note that in the generating step, a support structure for supporting the first region from below may be generated in addition to the support structure for supporting the second region from below. For example, when the first region is not included in the second region, the support structure for supporting the first region from below may be generated. In this way, the support structure for supporting the region directly selected by the user is reflected in the molding data, and thus the convenience of the user can be further enhanced. In the following description, generating data representing a support structure, that is, support data, is also simply referred to as generating a support structure.

In step S65, the data generation section 411 executes display process. The display process is a process of displaying the second region determined in the region determining step on the display section 480. In the present embodiment, in the display processing, the data generation section 411 further displays the support structure generated in the generating step on the display section 480 in addition to the second region. A step of executing the display process is also referred to as a displaying step.

In step S70, the data generation section 411 determines whether or not to continue the data generation process. In the present embodiment, the data generation section 411 receives a selection by the user regarding whether or not to continue the data generation process, and determines whether or not to continue the data generation process based on the selection result. When the data generation process is continued, that is, when the data generation process is not completed, the data generation section 411 returns the process to step S30. When the data generation process is not continued, the data generation section 411 completes the data generation process. In another embodiment, the data generation section 411 may complete the data generation process when the generating process is executed a predetermined number of times, or may complete the data generation process without executing step S70.

Note that, in a case where the process is returned to step S30 in accordance with the determination result of step S70, the characteristic condition different from that of the previous step S30 may be determined in step S30 performed again. In step S40 performed again, in a case where the same region as the first region selected in the previous step S40 is selected, the data generation section 411 may display a warning on the display section 480, for example. In step S50 performed again, the data generation section 411 may or may not exclude the region determined as the second region in the previous step S50 from the region that can be determined as the second region. When the region determined as the second region in the previous step S50 is not excluded from the region to be determined as the second region, in step S60 performed again, the data generation section 411 may or may not exclude the portion where the support structure has already been generated in the previous step S50 from the portion where the support structure can be generated.

In step S80, the control section 300 of the three dimensional molding device 100 acquires the second molding data generated in step S70 from the information processing device 400. When the generation process is executed a plurality of times, the second molding data acquired in step S70 includes support data generated in each generation process. In step S90, the control section 300 controls the ejection section 60 and the movement mechanism 230 according to the second molding data acquired in step S80, and molds the three dimensional molded object, that is, the model and the support structure on the molding surface 211 of the stage 210.

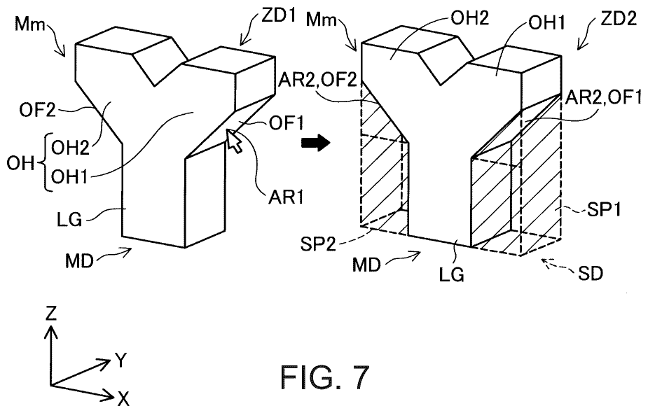

FIG. 7 is a diagram showing a first example of the data generation process in the first embodiment. FIG. 7 shows an example of a case where only the equal angle condition is selected as the characteristic condition in step S30 of FIG. 6.

A first molding data ZD1 including a model data MD representing a model Mm is shown on the left side of FIG. 7. The model Mm has a substantially Y-shape as viewed in the Y direction. The model Mm includes a leg section LG and an overhang section OH. The overhang section OH includes a first overhang section OH1 and a second overhang section OH2. The leg section is molded so that the lower surface thereof directly or indirectly contacts the molding surface 211 of the stage 210 in the three dimensional molding. The leg section LG has a substantially rectangular parallelepiped shape. The first overhang section OH1 protrudes from an upper end section of the leg section LG in the +X direction. The first overhang section OH1 has a first overhang surface OF1 that is an overhang surface of the first overhang section OH1. The overhang surface is a surface of the overhang section facing the molding surface 211. The first overhang surface OF1 is a plane parallel to a Y-axis and inclined with respect to an X-axis and a Z-axis. The +X direction side of the first overhang surface OF1 is positioned on the +Z direction side of the −X direction side of the first overhang surface OF1. The second overhang section OH2 protrudes from the upper end section of the leg section LG in the −X direction. The second overhang section OH2 has a second overhang surface OF2 that is an overhang surface of the second overhang section OH2. The second overhang surface OF2 is a plane parallel to the Y-axis and inclined with respect to the X-axis and the Z-axis. The −X direction side of the second overhang surface OF2 is positioned on the +Z direction side of the +X direction side of the second overhang surface OF2.

The left side of FIG. 7 shows how a first region AR1 is selected in step S40 of FIG. 6. The first region AR1 is a facet included in the first overhang surface OF1. In the example of FIG. 7, when the first region AR1 is selected in this manner, in step S50 of FIG. 6, first, the characteristic angle of the first region AR1 is acquired as the characteristic amount of the first region AR1. Next, as shown on the right side of FIG. 7, the region of the overhang section OH that satisfies the equal angle condition is determined as a second region AR2 based on the acquired characteristic angle. More specifically, in the example of FIG. 7, a region including all facets having the same angle as the characteristic angle of the first region AR1 in the overhang surface of the overhang section OH is determined as the second region AR2. That is, in the example of FIG. 7, the first overhang surface OF1 and the second overhang surface OF2 are determined as the second region AR2.

In the example of FIG. 7, the first overhang surface OF1 determined as the second region AR2 corresponds to the first partial region. The second overhang surface OF2 determined as the second region AR2 corresponds to the second partial region. The first partial region is a region including the first region or adjacent to the first region. The second partial region is a region that is not continuous with the first partial region, does not include the first region, and is not adjacent to the first region. The expression “the first partial region and the second partial region are not continuous” means that the first partial region and the second partial region do not belong to one continuous region.

In the example of FIG. 7, a support data SD representing the support structure for supporting the second region AR2 is generated in step S60 of FIG. 6. As a result, in the example of FIG. 7, the second molding data ZD2 including the model data MD and the support data SD is generated. The support data SD represents a support structure SP1 for supporting the first overhang surface OF1 and a support structure SP2 for supporting the second overhang surface OF2. On the right side of FIG. 7, the support structures is hatched. The support structure SP1 is generated below the first overhang surface OF1. More specifically, the support structure SP1 is generated on the +X direction side of the leg section LG such that the lower surface thereof is directly or indirectly in contact with the molding surface 211 and the upper end section of the support end section thereof is in contact with the first overhang surface OF1 from below. In substantially the same way, the support structure SP2 is generated below the second overhang surface OF2. The support structure SP2 is positioned on the −X direction side of the leg section LG.

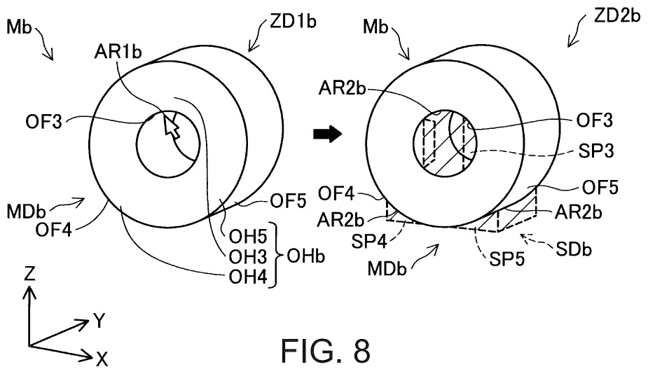

FIG. 8 is a diagram showing a second example of the data generation process according to the first embodiment. FIG. 8 shows an example of a case where only the less than angle condition is selected as the characteristic condition in step S30 of FIG. 6. In FIG. 8, the support structure is hatched, as in FIG. 7.

A first molding data ZD1b including a model data MDb representing a model Mb is shown on the left side of FIG. 8. The model Mb has a substantially cylindrical shape and is disposed such that the axial direction thereof is along the Y direction. The model Mb includes an overhang section OHb. The overhang section OHb includes a third overhang section OH3, a fourth overhang section OH4, and a fifth overhang section OH5. The third overhang section OH3 is a portion of the model Mb positioned on the +Z direction side of the hollow section positioned in the central section of the model Mb. The third overhang section OH3 has a third overhang surface OF3 that is an overhang surface of the third overhang section OH3. The third overhang surface OF3 is a curved surface constituting the lower surface of the third overhang section OH3. The fourth overhang section OH4 is a portion constituting one fourth of the model Mb on the −X direction side and the −Z direction side, that is, a portion constituting a half of the lower half of the model Mb on the −X direction side. The fourth overhang section OH4 has a fourth overhang surface OF4 that is an overhang surface of the fourth overhang section OH4. The fourth overhang surface OF4 is a curved surface constituting the lower surface of the fourth overhang section OH4. The fifth overhang section OH5 is a portion constituting one fourth of the model Mb on the +X direction side and the −Z direction side, that is, a portion constituting a half of the lower half of the model Mb on the +X direction side. The fifth overhang section OH5 has a fifth overhang surface OF5 that is an overhang surface of the fifth overhang section OH5. The fifth overhang surface OF5 is a curved surface constituting the lower surface of the fifth overhang section OH5.

The left side of FIG. 8 shows how a first region AR1b is selected in step S40 of FIG. 6. The first region AR1b is a facet included in the third overhang surface OF3. In the example of FIG. 8, when the first region AR1b is selected in this manner, in step S50 of FIG. 6, a region of the overhang section OHb that satisfies the less than angle condition is determined as a second region AR2b based on the characteristic angle of the first region AR1b, as shown on the right side of FIG. 8. More specifically, in the example of FIG. 8, a region including all facets having an angle less than the characteristic angle of the first region AR1b in the overhang surface of the overhang section OHb is determined as the second region AR2b. In the example of FIG. 8, a part of the third overhang surface OF3, a part of the fourth overhang surface OF4, and a part of the fifth overhang surface OF5 are determined as the second region AR2b.

In the example of FIG. 8, the third overhang surface OF3 determined as the second region AR2b corresponds to the first partial region. The fourth overhang surface OF4 and the fifth overhang surface OF5 determined as the second region AR2 correspond to the second partial region.

In the example of FIG. 8, a support data SDb representing the support structure for supporting the second region AR2b is generated in step S60 of FIG. 6. As a result, in the example of FIG. 8, the second molding data ZD2b including the model data MDb and the support data SDb is generated. The support data SDb represents a support structure SP3 for supporting a part of the third overhang surface OF3, a support structure SP4 for supporting a part of the fourth overhang surface OF4, and a support structure SP5 for supporting a part of the fifth overhang surface OF5 The support structure SP3 is generated below the third overhang surface OF3. More specifically, the support structure SP3 is generated in the hollow section of the model Mm such that the lower end section thereof is in contact with at least a part of the lower half of the inner circumferential surface of the model Mb and the upper end section thereof is in contact with the third overhang surface OF3 from below. The support structure SP4 is generated below the fourth overhang surface OF4. More specifically, the support structure SP4 is generated such that the lower surface thereof is directly or indirectly in contact with the molding surface 211 and the upper end section thereof is in contact with the fourth overhang surface OF4 from below. The support structure SP5 is generated below the fifth overhang surface OF5 in substantially the same way as the support structure SP4.

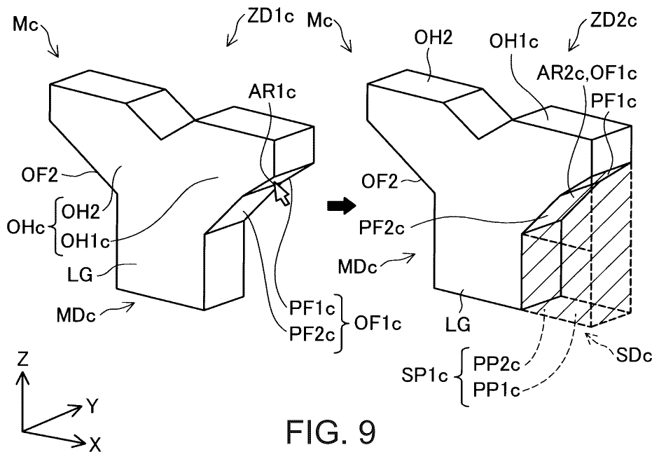

FIG. 9 is a diagram showing a third example of the data generation process according to the first embodiment. FIG. 9 shows an example of a case where only the adjacent continuous condition is selected as the characteristic condition in step S30 of FIG. 6. In FIG. 9, the support structure is hatched, as in FIG. 7. In the example of FIG. 9, points that are not particularly described are the same as those in the example of FIG. 7.

A first molding data ZD1c including a model data MDc representing a model Mc is shown on the left side of FIG. 9. The model Mc has a substantially Y-shape as viewed in the Y direction. The model Mc includes a leg section LG and an overhang section OHc. The overhang section OHc includes a first overhang section OH1c and a second overhang section OH2. In the overhang section OHc, points that are not particularly described are the same as those of the overhang section OH. The first overhang section OH1c has a first overhang surface OF1c. The first overhang surface OF1c includes a first surface portion PF1c and a second surface portion PF2c. The first surface portion PF1c and the second surface portion PF2c are planes parallel to the Y-axis and inclined with respect to the X-axis and the Z-axis. The second surface portion PF2c is positioned on the −X direction side of the first surface portion PF1c and is adjacent to the first surface portion PF1c in the X direction. The molding angle of the first surface portion PF1c is smaller than the molding angle of the second surface portion PF2c. An angle difference between the molding angle of the first surface portion PF1c and the molding angle of the second surface portion PF2c is equal to or less than a reference value. The first overhang surface OF1c corresponds to the continuous region. That is, the first surface portion PF1c and the second surface portion PF2c are included in the same continuous region.

The left side of FIG. 9 shows how a first region AR1c is selected in step S40 of FIG. 6. The first region AR1c is a facet included in the first surface portion PF1c of the first overhang surface OF1. In the example of FIG. 9, when the first region AR1c is selected in this manner, in step S50 of FIG. 6, a region of the overhang section OHc that satisfies the adjacent continuous condition is determined as a second region AR2c based on the characteristic angle of the first region AR1c, as shown on the right side of FIG. 9. More specifically, when the first region AR1c is selected, the first overhang surface OF1c corresponds to the adjacent continuous region including one or more facets as the first adjacent region. The second overhang surface OF2 does not correspond to the adjacent continuous region. As a result, in the example of FIG. 9, the first overhang surface OF1c is determined as the second region AR2c, whereas the second overhang surface OF2 is not determined as the second region AR2c. That is, in the example of FIG. 9, unlike the example of FIG. 7, the second region AR2c includes only the first overhang surface OF1c and does not include the second overhang surface OF2.

In the example of FIG. 9, a support data SDc representing the support structure for supporting the second region AR2c is generated in step S60 of FIG. 6. As a result, in the example of FIG. 9, the second molding data ZD2c including the model data MDc and the support data SDc is generated. The support data SDc represents the support structure SP1c for supporting the first overhang surface OF1c. The support structure SP1c is generated on the lower side of the first overhang surface OF1c. The support structure SP1c includes a first support portion PP1c for supporting the first surface portion PF1c and a second support portion PP2c for supporting the second surface portion PF2c. The first support portion PP1c is generated on the lower side of the first surface portion PF1c. The second support portion PP2c is generated on the lower side of the second surface portion PF2c.

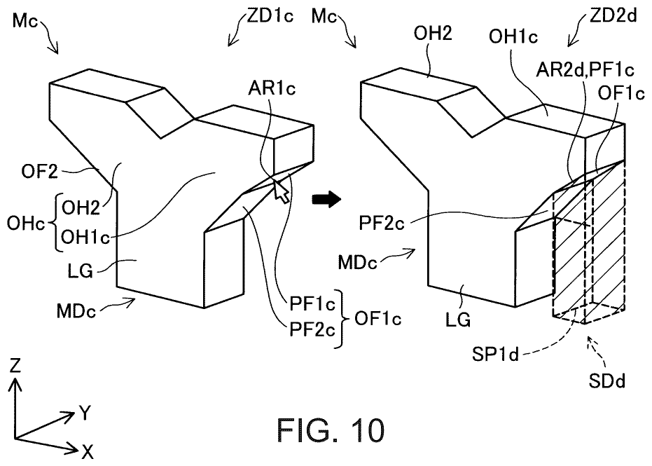

FIG. 10 is a diagram showing a fourth example of the data generation process according to the first embodiment. FIG. 10 shows an example of a case where the adjacent continuous condition and the equal angle condition are selected as the characteristic conditions in step S30 of FIG. 6. In FIG. 10, the support structure is hatched, as in FIG. 7. In the example of FIG. 10, points that are not particularly described are the same as those in the example of FIG. 9.

The left side of FIG. 10 shows how a first region AR1c is selected in step S40 of FIG. 6 for the first molding data ZD1c. In the example of FIG. 10, when the first region AR1c is selected in this manner, in step S50 of FIG. 6, a region of the overhang section OHc that satisfies both the adjacent continuous condition and the equal angle condition is determined as a second region AR2d, as shown on the right side of FIG. 10, based on the characteristic angle of the first region AR1c. More specifically, in the example of FIG. 10, the first overhang surface OF1c corresponds to the adjacent continuous region, as in the example of FIG. 9. Then, all facets of the first overhang surface OF1c having a same angle as the characteristic angle of the first region AR1c, that is, all of the first surface portions PF1c, are determined as the second region AR2d. As a result, in the example of FIG. 10, unlike the example of FIG. 9, the second region AR2d includes only the first surface portion PF1c and does not include the second surface portion PF2c.

In the example of FIG. 10, a support data SDd representing the support structure SP1d for supporting the second region AR2d is generated in step S60 of FIG. 6. As a result, in the example of FIG. 10, the second molding data ZD2d including the model data MDc and the support data SDd is generated. Unlike the support structure SP1c shown in FIG. 9, the support structure SP1d includes only the support structure corresponding to the first support portion PP1c and does not include the support structure corresponding to the second support portion PP2c.

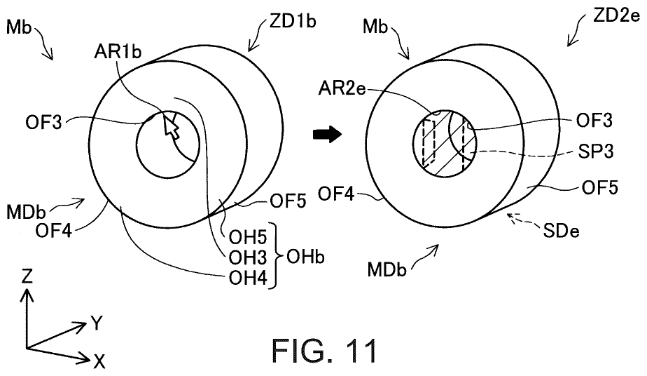

FIG. 11 is a diagram showing a fifth example of the data generation process according to the first embodiment. FIG. 11 shows an example of a case where the adjacent continuous condition and the less than angle condition are selected as the characteristic conditions in step S30 of FIG. 6. In FIG. 11, the support structure is hatched as in FIG. 7. In the example of FIG. 11, points that are not particularly described are the same as those in the example of FIG. 8.

The left side of FIG. 11 shows how a first region AR1b is selected in step S40 of FIG. 6 for the first molding data ZD1b. In the example of FIG. 11, when the first region AR1b is selected in this manner, in step S50 of FIG. 6, a region of the overhang section OHb that satisfies both the adjacent continuous condition and the less than angle condition is determined as a second region AR2e, as shown on the right side of FIG. 11, based on the characteristic angle of the first region AR1b. More specifically, when the first region AR1b is selected, the third overhang surface OF3 corresponds to the adjacent continuous region including one or more facets as the first adjacent region. Then, all facets of the third overhang surface OF3 having a molding angle less than the characteristic angle of the first region AR1b are determined as the second region AR2e. As a result, in the example of FIG. 11, unlike the example of FIG. 8, the second region AR2e does not include the fourth overhang surface OF4 and the fifth overhang surface OF5 at all.

In the example of FIG. 11, a support data SDe representing the support structure for supporting the second region AR2e is generated in step S60 of FIG. 6. As a result, in the example of FIG. 10, the second molding data ZD2e including the model data MDb and the support data SDe is generated. The support structure in the example of FIG. 11 includes only the support structure SP3, unlike the example of FIG. 8.

According to the three dimensional molded object manufacturing method in the present embodiment described above, the selection of the first region is received on the display section 480, the second region is determined based on the selected first region, and the support data representing the support structure for supporting the determined second region from below is generated. Here, unlike the present embodiment, for example, in a case where the support data is automatically generated based on a predetermined condition without depending on the selection of the user, there is a possibility that the support structure desired by the user is not reflected in the molding data used for the three dimensional molding or a possibility that the support structure not desired by the user is reflected in the molding data. On the other hand, for example, it is inefficient for the user to set the desired support structures one by one manually. In contrast, in the present embodiment, the second region is automatically determined based on the first region in which the user's desire is reflected, and the support data representing the support structure for supporting the second region from below is automatically generated. Therefore, it is possible to efficiently generate the molding data reflecting the desired support structure.

In the examples of FIG. 7 and FIG. 10 in the present embodiment, a region of the overhang section that satisfies the equal angle condition is determined as the second region. In this way, since the region having the same molding angle as the characteristic angle of the first region can be determined as the second region, the support structure having a higher probability of being structurally desired can be reflected in the molding data, and the possibility that the undesired support structure is reflected in the molding data can be further reduced.

In the examples of FIG. 8 and FIG. 11 in the present embodiment, a region of the overhang section that satisfies the less than angle condition is determined as the second region. Since in the region of the overhang section that satisfies the less than angle condition, the lower surface is closer to being parallel to the molding surface 211 than the first region, the region is a region that is a higher probability of requiring the support structure during three dimensional molding. As described above, in the present embodiment, a region having a higher probability of requiring the support structure than the first region in terms of structure can be determined as the second region, and the molding data reflecting the support structure having a higher probability of being desired can be generated more efficiently.

In the examples of FIG. 9 to FIG. 11 in the present embodiment, a region having the molding angle whose angle difference from the characteristic angle of the first region is equal to or less than the angle threshold in the overhang section is determined as the second region. Therefore, the support structure that is highly probability to be desired structurally can be reflected in the molding data. Note that the angle threshold is desirably larger than 0 degrees from the viewpoint of more efficiently generating the support structure. The angle threshold is desirably equal to or less than 10 degrees, and more desirably equal to or less than 5 degrees, from the viewpoint of further reducing the possibility that an undesired support structure is reflected in the molding data.

In the examples of FIG. 9 to FIG. 11 in the present embodiment, the first adjacent region of the overhang section is determined as the second region. Therefore, the support structure that is highly probability to be desired structurally and positionally can be reflected in the molding data.

In the present embodiment, in the examples of above described FIG. 9 to FIG. 11, the adjacent continuous region including the first adjacent region in the overhang section is determined as the second region. Therefore, the molding data reflecting the support structure that is a higher probability to be desired structurally and positionally can be generated more efficiently.

In the present embodiment, in the displaying step, the second region determined in the determination step is displayed on the display section 480. Therefore, the user can confirm the determined second region as visual information.

Note that in another embodiment, in the displaying step, the support structure for supporting the first partial region and the support structure for supporting the second partial region may be displayed on the display section 480 in different display modes. The different display modes mean that at least one of the color and the pattern is different. For example, in the example of FIG. 7, the first support portion PP1c may be displayed in red and the second support portion PP2c may be displayed in blue on the display section 480. For example, the first support portion PP1c may be displayed in a striped pattern, and the second support portion PP2c may be displayed in a dotted pattern or the like. In this way, the support structure for supporting the first partial region and the support structure for supporting the second partial region can be displayed on the display section 480 in a visually distinguishable manner.

In the present embodiment, when the second region is not determined in the region determining step, a warning is displayed on the display section 480. Therefore, when the second region is not determined, for example, the user can be prompted to confirm whether or not the selection of the first region is appropriate or whether or not the setting of the characteristic condition is appropriate.

### B. Second Embodiment

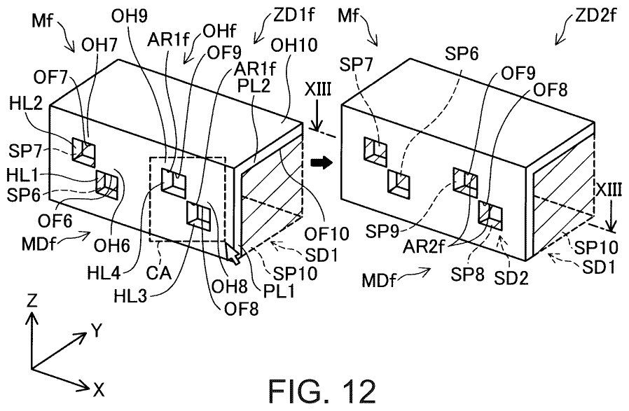

FIG. 12 is a schematic diagram showing a first example of a data generation process according to a second embodiment. In the second embodiment, unlike the first embodiment, in the receive process, the data generation section 411 is configured to be able to receive selection of a plurality of facets included in the overhang section as the first region. In FIG. 12, the support structure is hatched as in FIG. 7. In the three dimensional molding device 100 and the information processing device 400 according to the present embodiment, points that are not particularly described are the same as those of the first embodiment.

A first molding data ZD1f including a model data MDf representing a model Mf is shown on the left side of FIG. 12. The model Mf has a first plate section PL1 and a second plate section PL2. The model Mf has an overhang section OHf. The overhang section OHf includes a sixth overhang section OH6, a seventh overhang section OH7, an eighth overhang section OH8, a ninth overhang section OH9, and a tenth overhang section OH10 (to be described later).

The first plate section PL1 has a rectangular flat plate-like shape, and is disposed such that the plate surface thereof extends along the X direction and the Z direction. The first plate section PL1 is molded such that an end section thereof on the −Z direction side is directly or indirectly in contact with the molding surface 211 in the three dimensional molding. The first plate section PL1 has a first hole section HL1, a second hole section HL2, a third hole section HL3, and a fourth hole section HL4. The opening shape of each of the hole sections from the first hole section HL1 to the fourth hole section HL4 is a rectangular shape, and penetrates the first plate section PL1 in a thickness direction. As a result, the first plate section PL1 has the sixth overhang section OH6, the seventh overhang section OH7, the eighth overhang section OH8, and the ninth overhang section OH9. The sixth overhang section OH6 is positioned above the first hole section HL1 and has a sixth overhang surface OF6. The seventh overhang section OH7 is positioned above the second hole section HL2 and has a seventh overhang surface OF7. The eighth overhang section OH8 is positioned above the third hole section HL3 and has an eighth overhang surface OF8. The ninth overhang section OH9 is positioned above the fourth hole section HL4 and has a ninth overhang surface OF9.

The second plate section PL2 has a rectangular flat plate-like shape, and is disposed such that the plate surface thereof extends along the X direction and the Y direction. The second plate section PL2 extends in the +Y direction from an end section of the first plate section PL1 on the +Z direction side. As a result, the second plate section PL2 has a tenth overhang section OH10. The tenth overhang section OH10 has a tenth overhang surface OF10.

As shown on the left side of FIG. 12, the first molding data ZD1f includes a first support data SD1 in addition to the model data MDf. The first support data SD1 represents a support structure SP6 for supporting the sixth overhang surface OF6, a support structure SP7 for supporting the seventh overhang surface OF7, and a support structure SP10 for supporting the tenth overhang surface OF10. The first molding data ZD If may be, for example, an molding data generated by another computer or an molding data generated as the second molding data in the first embodiment or the second embodiment.

In the present embodiment, the same molding process as the molding process shown in FIG. 6 is executed. However, in the receive process of step S40 in the present embodiment, the data generation section 411 causes the user to select the selection region on the display section 480 via the input device 470, thereby causing the user to select the first region included in the selection region. More specifically, in the receive process, first, the data generation section 411 causes the user to select a rectangular shape selection region by causing the user to select an arbitrary region in the three dimensional space by dragging. The selection region thus selected may include one or more facets. The data generation section 411 then receives each facet representing the overhang surface included in the selection region as the selected first region. On the left side of FIG. 12, one or more facets representing the eighth overhang surface OF8 and one or more facets representing the ninth overhang surface OF9 included in a selected region CA are received as a first region AR1f.

In the present embodiment, the characteristic angle and a characteristic opening area are acquired as the characteristic amount of the first region. As the characteristic angle in the present embodiment, the molding angles of all the facets included in the first region are used. The characteristic opening area means the opening area of the corresponding hole section for the first region. The “corresponding hole section” for a certain region means the hole section positioned directly below the region. The characteristic opening area is acquired when the corresponding hole section for the first region is present, and is not acquired when the corresponding hole section for the first region is not present. Note that, as the opening area of the hole section, for example, the opening area of the opening surface of the hole section may be used. For example, when the opening area of the hole section is not constant in the depth direction of the hole section, an average value of the opening area of the hole section in a depth direction may be used. The “depth direction of the hole section” means a direction orthogonal to an opening cross section of the hole section.

In the present embodiment, in step S30 of FIG. 6, the equal angle condition and a hole section condition are determined as the characteristic condition. The hole section condition is a condition that the opening area of the corresponding hole section for the determination target region is larger than the characteristic opening area. In the present embodiment, in step S50, among the regions having the molding angle equal to any of the acquired characteristic angles, a region in which the opening area of the corresponding hole section is larger than the characteristic opening area is determined as the second region. As a result, in the present embodiment, the hole section having the opening area equal to or smaller than the reference area is not determined as the second region, and the support structure is not generated in the hole section having the opening area equal to or smaller than the reference area. The opening areas of the first hole section HL1 to the fourth hole section HL4 shown in FIG. 12 are larger than the reference area.

On the right side of FIG. 12, a second region AR2f determined in the region determination process of step S50 of FIG. 6 is shown. In the example of FIG. 12, a region satisfying the equal angle condition and the hole section condition in the first region AR1f is determined as the second region AR2f. More specifically, in the example of FIG. 12, the eighth overhang surface OF8 and the ninth overhang surface OF9 are determined as the second region AR2f. Further, the second support data SD2 generated in step S60 generation process of FIG. 6 is shown on the right side of FIG. 12. In the present embodiment, the second molding data ZD2f including the model data MDf, the first support data SD1, and the second support data SD2 is generated by executing the generation process. The second support data SD2 represents the support structure SP8 for supporting the eighth overhang surface OF8 and the support structure SP9 for supporting the ninth overhang surface OF9. The support structure SP8 is generated below the eighth overhang surface OF8. More specifically, the support structure SP8 is generated in the third hole section HL3 such that the lower end section of the support structure SP8 contacts the lower wall that defines the third hole section HL3 and the upper end of the support structure SP8 contacts the eighth overhang surface OF8 from below. The support structure SP9 is generated below the ninth overhang surface OF9, that is, in the fourth hole section HL4, substantially similarly to the support structure SP8.

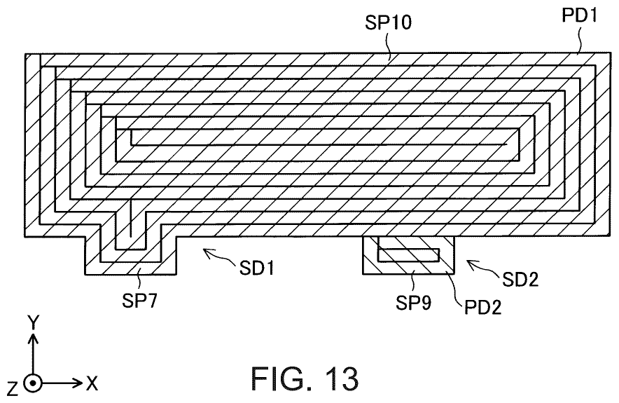

FIG. 13 is a diagram showing a first example of the path information included in the support data. FIG. 13 corresponds to a cross-sectional view taken along line XIII-XIII of the support structures SP7, SP9, and SP10 shown in FIG. 12. That is, FIG. 13 shows a cross section of one layer of the three dimensional molded object including the support structures SP7, SP9, and SP10 along the XY direction. In the example of FIG. 13, the first support data SD1 includes path information of a first path PD1. The first path PD1 is a movement path for molding the support structures SP7 and SP10. The second support data SD2 includes path information of a second path PD2, and the second path PD2 is a movement path for forming the support structure SP9. In the example of FIG. 13, the second path PD2 is another movement path that is not connected to the first path PD1. The filling rate achieved by the second path PD2 is the same as the filling rate achieved by the first path PD1.

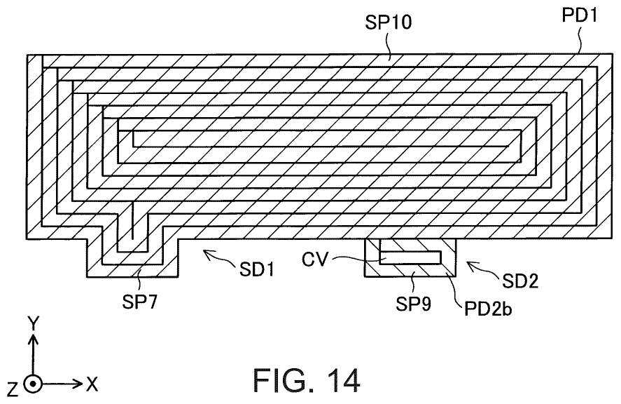

FIG. 14 is a diagram showing a second example of the path information included in the support data. FIG. 14 shows the support structures SP7, SP9, and SP10 in a similar manner to FIG. 13. In the example of FIG. 14, the second support data SD2 includes path information of a second path PD2b. The filling rate achieved by the second path PD2b is lower than the filling rate achieved by the first path PD1. As a result, the support structure SP9 in the example of FIG. 14 has a void section CV that is not filled with the molding material, unlike the example of FIG. 13.

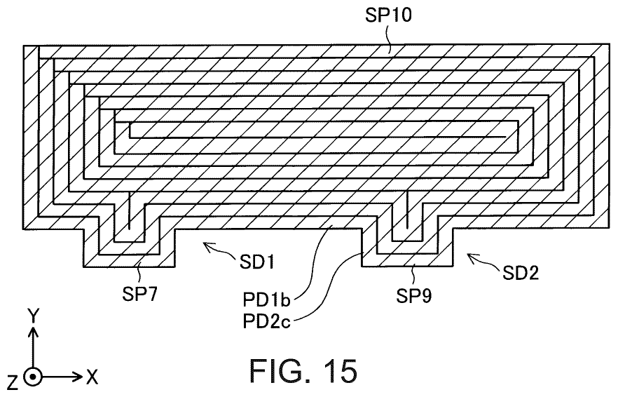

FIG. 15 is a diagram showing a third example of the path information included in the support data. FIG. 15 shows the support structures SP7, SP9, and SP10 in a similar manner to FIG. 13. In the example of FIG. 15, the first support data SD1 includes path information of a first path PD1b. The second support data SD2 includes path information of a second path PD2c. Unlike the second paths PD2 and PD2b, the second path PD2c is a path connected to the first path PD1b.

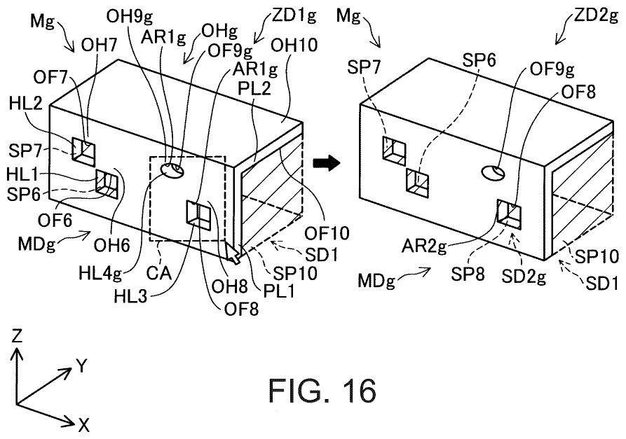

FIG. 16 is a diagram showing a second example of the data generation process in the second embodiment. In FIG. 16, the support structure is hatched, as in FIG. 12. In the example of FIG. 16, points that are not particularly described are the same as those in the example of FIG. 12.

A first molding data ZD1g representing a model data MDg representing a model Mg is shown on the left side of FIG. 16. The model Mg has a fourth hole section HL4g instead of the fourth hole section HL4, unlike the model Mf. The opening shape of the fourth hole section HL4g is an oval shape, unlike the opening shapes of the other hole sections such as the first hole section HL1. The opening area of the fourth hole section HL4g is smaller than the opening area of the other hole sections such as the first hole section HL1. The opening area of the fourth hole section HL4g is equal to or less than the reference area. An overhang section OHg of the model Mg includes a ninth overhang section OH9g instead of the ninth overhang section OH9. The ninth overhang surface OF9g is a curved surface constituting the lower surface of the ninth overhang section OH9g. In the configuration of the model Mg, points that are not particularly described are the same as those of the model Mf.

In the example of FIG. 16, by selecting the selected region CA in step S40 of FIG. 6, one or more facets representing the eighth overhang surface OF8 and one or more facets representing the ninth overhang surface OF9g are received as the first region AR1g. In the example of FIG. 16, in step S50 of FIG. 6, the eighth overhang surface OF8 that satisfies the equal angle condition and the hole section condition is determined as a second region AR2g, whereas the ninth overhang surface OF9g that satisfies only the equal angle condition and does not satisfy the hole section condition is not determined as the second region AR2g. In the example of FIG. 16, a second support data SD2g is generated based on the second region AR2g in step S60 of FIG. 6. As a result, in the example of FIG. 16, a second molding data ZD2g including the model data MDg, the first support data SD1, and the second support data SD2g is generated. The support structure represented by the second support data SD2g thus generated includes the support structure SP8 for supporting the eighth overhang surface OF8, but does not include the support structure for supporting the ninth overhang surface OF9.

By also in the three dimensional molded object manufacturing method according to the present embodiment described above, the second region is automatically determined based on the first region in which the desire of the user is reflected, and the support data representing the support structure for supporting the determined second region from below is automatically generated. Therefore, it is possible to efficiently generate the molding data reflecting the desired support structure.

In the present embodiment, the support structure is not generated in the hole section having the opening area equal to or smaller than the reference area. Here, in a case where the support structure is generated in the hole section having a smaller opening area, the support structure is more firmly adhered to the wall section of the hole section, compared to a case where the support structure is generated in the hole section having a larger opening area. This is because the ratio of the area of the contact surface to the volume of the support structure increases when the support structure is generated in the hole section with a smaller opening area. The contact surface here refers to a surface of the support structure that contacts the model, more specifically, a surface that contacts the wall section of the hole section. As a result, when the support structure is generated in the hole section having a smaller opening area, it takes more time to detach the support structure from the model after the three dimensional molding. In the present embodiment, by not generating a support structure in the hole section having an opening area equal to or less than the reference area, it is possible to improve convenience regarding detachment of the support structure from the model. The support structure generated in the hole section having a smaller opening area tends to have a smaller contribution to the support of the model during the three dimensional molding, compared to the support structure generated in the hole section having a larger opening area. Therefore, by not generating the support structure in the hole section having the opening area equal to or less than the reference area, it is possible to reduce the possibility of generating an unnecessary support structure.

Note that in another embodiment, the data generation section 411 may make at least one of the shape and the density of the support structure different between a case where the support structure is generated in the hole section having the opening area equal to or smaller than the reference area and a case where the support structure is generated in the hole section having the opening area larger than the reference area. The difference in shape of the support structure may be, for example, whether it is branch-shaped or block-shaped. In this case, for example, the data generation section 411 may generate the branch-shaped support structure for the hole section having an opening area equal to or smaller than the reference area, and generate the block-shaped support structure for the hole section having an opening area larger than the reference area. The branch-shaped support structure tends to have a smaller contact area with the model than the block-shaped support structure. Therefore, by generating the branch-shaped support structure in the hole section having an opening area equal to or smaller than the reference area, it is possible to improve convenience regarding detachment of the support structure from the model while generating the support structure in the hole section having an opening area equal to or smaller than the reference area. The difference in the shape of the support structure may be realized by, for example, a difference in the infill pattern of the movement path for molding the support structure. In this case, it is desirable that the support structure is generated in the hole section having an opening area equal to or less than the reference area by the infill pattern in which a contact area with the model is smaller. In a case where the density of the support structure is made different, the data generation section 411 may generate the high-density support structure for the hole section having an opening area equal to or less than the reference area and the low-density support structure for the hole section having an opening area larger than the reference area. Such a difference in the density of the support structure can be achieved, for example, by the different filling rate in the support structure. According to this aspect, it is also possible to improve convenience related to detachment of the support structure from the model while generating the support structure in the hole section having the opening area equal to or smaller than the reference area.

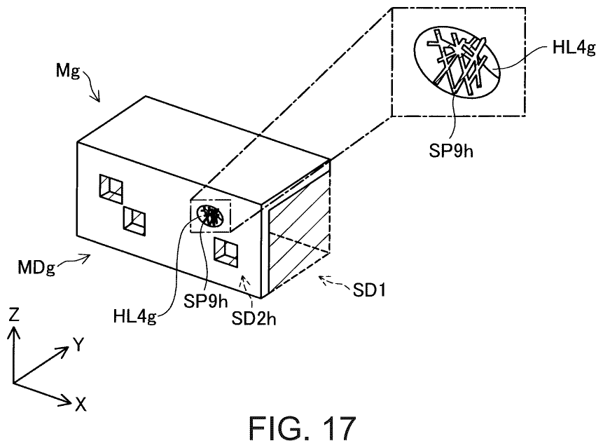

For example, FIG. 17 is a diagram showing a first example of the data generation process according to another embodiment. In FIG. 17, the support structure is hatched as in FIG. 12. In the example of FIG. 17, points that are not particularly described are the same as those in the example of FIG. 16. FIG. 17 shows a second support data SD2h generated in step S60 of FIG. 6. The support structure represented by a second support data SD2h includes a support structure SP9h generated in the fourth hole section HL4g. The support structure SP9h is a branch-shaped support structure, unlike the support structure SP9. As a result, the support structure can be more easily detached from the model Mg after the three dimensional molding compared to a case where the block-shaped support structure is generated in the fourth hole section HL4g.

### C. Other Embodiments

(C-1) In each of the above embodiments, for example, a first selection mode in which one facet is selected as the first region as in the first embodiment and a second selection mode in which a plurality of facets can be selected as the first region as in the second embodiment may be configured to be designated by the user. In this case, the data generation section 411 may receive the designation of the selection mode, for example, prior to the receiving step.

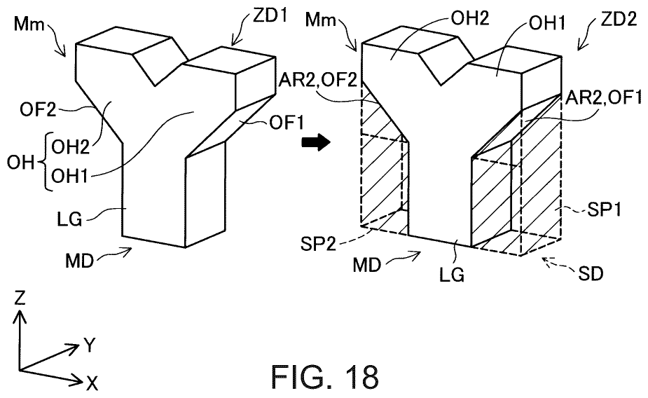

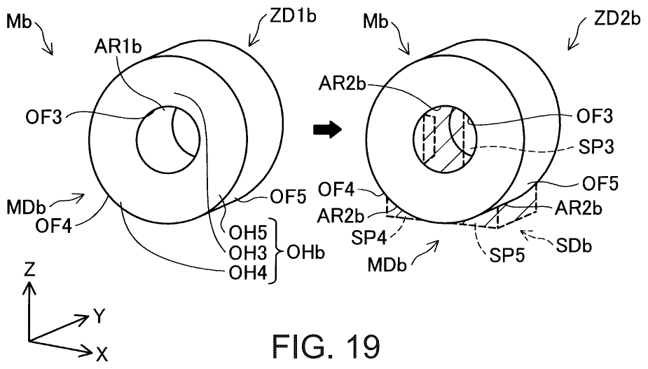

The data generation section 411 may have an automatic selection mode in addition to a mode of determining the second region based on the selection of the first region, for example. The automatic selection mode is a mode in which the designation of the characteristic amount by the user is received without executing the receiving step, that is, without receiving the selection of the first region, and the second region is selected based on the designated characteristic amount. In the automatic selection mode, the data generation section 411 determines a region satisfying the characteristic condition as the second region based on the designated characteristic amount. For example, FIG. 18 is a diagram showing a second example of the data generation process according to another embodiment. In FIG. 18, the model Mm and the support structures SP1 and SP2 are shown in the similar manner as in FIG. 7. FIG. 18 shows an example of a case where only the equal angle condition is selected as the characteristic condition. In the example of FIG. 18, the same characteristic angle as the molding angle of the first overhang surface OF1 is designated by the user, and the second region AR2 is determined based on the designated characteristic angle. Further, for example, FIG. 19 is a diagram showing a third example of the data generation process according to another embodiment. In FIG. 19, the model Mb and the support structures SP3, SP4, and SP5 are shown in the similar manner as in FIG. 8. FIG. 19 shows an example of a case where only the less than angle condition is selected as the characteristic condition. In the example of FIG. 19, the same characteristic angle as the molding angle of one facet included in the third overhang surface OF3 is designated by the user, and the second region AR2 is determined based on the designated characteristic angle.

(C-2) Not limited to the second embodiment, in each of the above embodiments, the hole section condition may be used as the characteristic condition in addition to the condition related to the characteristic angle such as the equal angle condition, the less than angle condition, and the adjacent continuous condition. The condition related to the characteristic angle may include a similar angle condition and an adjacent condition in addition to or instead of the equal angle condition, the less than angle condition, and the adjacent continuous condition. The similar angle condition is a condition that the angle difference between the molding angle of the determination target region and the characteristic angle is equal to or less than a predetermined threshold. For example, when only the similar angle condition is used as the characteristic condition, unlike the case where the adjacent continuous condition is used as the characteristic condition, a region having the molding angle whose angle difference from the characteristic angle is equal to or less than the threshold is determined as the second region regardless of whether or not the region is adjacent to the first region. The adjacent condition is a condition that the determination target region is a first adjacent condition.

(C-3) In each of the above embodiments, the condition determination process may not be executed. In this case, the data generation section 411 may use, for example, one combination of characteristic conditions determined in advance in the region determination process. In this case, as the characteristic condition, for example, any one of the equal angle condition, the less than angle condition, and the adjacent continuous condition, a combination of any two of the conditions, or a combination of all three of the conditions may be used. In addition to the condition related to the characteristic angle, for example, the hole section condition may be used as the characteristic condition.

(C-4) In the first embodiment, for example, only one or two of the equal angle condition, the less than angle condition, and the adjacent continuous condition may be selectable as the characteristic condition. In addition to or instead of the equal angle condition, the less than angle condition, and the adjacent continuous condition, other conditions such as the hole section condition may be selectable.

(C-5) In the second embodiment, the characteristic condition may include, for example, at least one of the less than angle condition and the adjacent continuous condition instead of or in addition to the equal angle condition. In the second embodiment, the condition regarding the characteristic angle may include the similar angle condition or the adjacent condition in addition to or instead of the equal angle condition, the less than angle condition, or the adjacent continuous condition. In the second embodiment, the characteristic condition may not include the hole section condition.

(C-6) In each of the above embodiments, in the display process, at least the second region determined in the region determining step may be displayed on the display section 480, and the support structure generated in the generating step may not be displayed on the display section 480. In the above embodiments, the display process is executed, but the display process may not be executed.

(C-7) In each of the above embodiments, the warning process is executed, but the warning process may not be executed.

### D. Other Forms

The present disclosure is not limited to the embodiments described above, but can be realized in various forms without departing from the scope of the present disclosure. For example, the present disclosure can also be realized by the following forms. The technical features in the above embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.

(1) According to an aspect of the present disclosure, there is provided a data generation method for generating molding data for molding a three dimensional molded object by ejecting a molding material onto a molding surface of a stage to stack layers of the molding material.

This data generation method includes a receiving step of displaying at least a part of an overhang section of the three dimensional molded object on a display section and of receiving selection of a first region representing at least a part of the overhang section on the display section; a region determining step of determining a second region representing at least a part of the overhang section based on a characteristic amount of the selected first region; and a generating step of generating data representing a support structure for supporting the determined second region from below in a stacking direction of the layers. the characteristic amount includes a characteristic angle representing an angle of the first region with respect to the molding surface.

According to this aspect, the selection of the first region is received on the display section, the second region is determined based on the selected first region, and the data representing the support structure for supporting the determined second region from below is generated. Therefore, it is possible to efficiently generate the molding data reflecting the desired support structure.

(2) The above aspect may be such that in the region determining step, a region of the overhang section having an angle equal to the characteristic angle is determined as the second region.

According to this aspect, the support structure having a higher probability of being structurally desired can be reflected in the molding data, and the possibility that the undesired support structure is reflected in the molding data can be further reduced.

(3) The above aspect may be such that in the region determining step, a region of the overhang section having an angle less than the characteristic angle is determined as the second region.

According to this aspect, a region having a higher probability of requiring the support structure than the first region in terms of structure can be determined as the second region, and the molding data reflecting the support structure having a higher probability of being desired can be generated more efficiently.

(4) The above aspect may be such that in the region determining step, a region of the overhang section having an angle whose angle difference from the characteristic angle is equal to or less than a predetermined threshold is determined as the second region.

According to this aspect, the support structure that is a higher probability to be structurally desired can be reflected in the molding data.

(5) The above aspect may be such that the region determined as the second region includes a region of the overhang section that has an angle whose angle difference with the characteristic angle is equal to or smaller than the threshold and that is adjacent to the first region.

According to this aspect, the support structure that is a higher probability to be desired structurally and positionally can be reflected in the molding data.

(6) The above aspect may be such that an adjacent continuous region is an adjacent continuous region including a plurality of adjacent regions including a region adjacent to the first region, in which an angle difference between the angles of the adjacent regions included in the adjacent continuous region is equal to or less than the threshold, is determined as the second region.

According to this aspect, the molding data reflecting the support structure that is a higher probability to be desired structurally and positionally can be generated more efficiently.

(7) The above aspect may further includes a displaying step of displaying the second region determined in the region determining step on the display section.

According to this aspect, the user can confirm the determined second region as visual information.

(8) The above aspect may be such that the second region has a first partial region that includes the first region or that is adjacent to the first region, and a second partial region that is a second partial region that is not continuous with the first partial region, that does not include the first region, and that is not adjacent to the first region and in the displaying step, the support structure for supporting the first partial region and the support structure for supporting the second partial region are displayed with at least one of a color and a pattern different from each other.

According to this aspect, the support structure for supporting the first partial region and the support structure for supporting the second partial region can be displayed on the display section in a visually distinguishable manner.

(9) The above aspect may further includes a warning step of displaying a warning on the display section when the second region is not determined in the region determining step, wherein in the region determining step, a region that satisfies a predetermined characteristic condition regarding the characteristic amount is determined as the second region.

According to this aspect, when the second region is not determined, for example, the user can be prompted to confirm whether or not the selection of the first region is appropriate or whether or not the setting of the characteristic condition is appropriate.

(10) The above aspect may be such that in the generating step, the data representing the support structure for supporting the selected first region from below in the stacking direction is further generated.

According to this aspect, the support structure for supporting the region directly selected by the user is reflected in the molding data, and thus the convenience of the user can be further enhanced.

The present disclosure is not limited to the data generation method described above, and can be realized by various aspects such as a three dimensional molded object manufacturing method, a three dimensional molding system, an information processing device, a computer program, and a non-transitory tangible recording medium in which a computer program is recorded in a computer-readable manner.

What is claimed is:

1. A data generation method for generating molding data for molding a three dimensional molded object by ejecting a molding material onto a molding surface of a stage to stack layers of the molding material, the data generation method comprising:
a receiving step of displaying at least a part of an overhang section of the three dimensional molded object on a display section and of receiving selection of a first region representing at least a part of the overhang section on the display section;
a region determining step of determining a second region representing at least a part of the overhang section based on a characteristic amount of the selected first region; and
a generating step of generating data representing a support structure for supporting the determined second region from below in a stacking direction of the layers, wherein
the characteristic amount includes a characteristic angle representing an angle of the first region with respect to the molding surface.

2. The data generation method according to claim 1, wherein
in the region determining step, a region of the overhang section having an angle equal to the characteristic angle is determined as the second region.

3. The data generation method according to claim 1, wherein
in the region determining step, a region of the overhang section having an angle less than the characteristic angle is determined as the second region.

4. The data generation method according to claim 1, wherein
in the region determining step, a region of the overhang section having an angle whose angle difference from the characteristic angle is equal to or less than a predetermined threshold is determined as the second region.

5. The data generation method according to claim 4, wherein
the region determined as the second region includes a region of the overhang section that has an angle whose angle difference with the characteristic angle is equal to or smaller than the threshold and that is adjacent to the first region.

6. The data generation method according to claim 5, wherein
in the region determining step, an adjacent continuous region is determined as the second region, the adjacent continuous region being an adjacent continuous region
that includes a plurality of adjacent regions including a region adjacent to the first region and
in which an angle difference between angles of the adjacent regions included in the adjacent continuous region is equal to or less than the threshold.

7. The data generation method according to claim 1, further comprising:
a displaying step of displaying the determined second region on the display section.

8. The data generation method according to claim 7, wherein
the second region has a first partial region that includes the first region or that is adjacent to the first region, and a second partial region that is a second partial region that is not continuous with the first partial region, that does not include the first region, and that is not adjacent to the first region and
in the displaying step, the support structure for supporting the first partial region and the support structure for supporting the second partial region are displayed with at least one of a color and a pattern different from each other.

9. The data generation method according to claim 1, further comprising:
a warning step of displaying a warning on the display section when the second region is not determined in the region determining step, wherein
in the region determining step, a region that satisfies a predetermined characteristic condition regarding the characteristic amount is determined as the second region.

10. The data generation method according to claim 1, wherein
in the generating step, the data representing the support structure for supporting the selected first region from below in the stacking direction is further generated.
